(19) United States
(12) Patent Application Publication
(10) Pub. No.: US 2011/0018961 A1
(43) Pub. Date: Jan. 27, 2011

(54) VIDEO CALL DEVICE AND METHOD

(75) Inventors: Jong-Hwa Choi, Gyeonggi-do (KR); Gyeong-Sic Jo, Gyeonggi-do (KR); Kwang-Ho Kim, Seoul (KR); Ju-Yeon Lee, Seoul (KR)

Correspondence Address: LANDO & ANASTASI, LLP, ONE MAIN STREET, SUITE 1100, CAMBRIDGE, MA, 02142, US

(73) Assignee: HUBORO CO., LTD., Gyeonnggi-do (KR)

(21) Appl. No.: 12/754,465

(22) Filed: Apr. 5, 2010

(30) Foreign Application Priority Data
Jul. 24, 2009 (KR) 10-2009-0067844
Oct. 28, 2009 (KR) 10-2009-0102706

(51) Int. Cl. H04N 7/14

(52) U.S. Cl. 348/14.12; 348/E07.078

(57) ABSTRACT

Provided are a video call device and method. The video call device performs a video call by exchanging images with another video call device in real time. The video call device includes: an image obtaining unit obtaining an original image in real time; an image processing unit comprising a first image conversion unit which receives the original image and converts the original image into a first conversion image in real time; and an interface unit transmitting the first conversion image.

This application claims priority from Korean Patent Application No. 10-2009-0067844 filed on Jul. 24, 2009 and Korean Patent Application No. 10-2009-0102706 filed on Oct. 28, 2009 in the Korean Intellectual Property Office, the disclosure of which is incorporated herein by reference in its entirety.

### BACKGROUND OF THE INVENTION

1. Field of the Invention

The present invention relates to a video call device and method, and more particularly, to a video call device and method employed to convert an original image and exchange the converted image with another video call device in real time.

2. Description of the Related Art

The improvements in the performance of personal computers, mobile phones, game devices, etc. are increasing the use of the display and transmission functions of moving images. Various devices offer a variety of solutions that provide services using moving images. These image-related solutions are drawing more attention along with the enhancement of the image quality and performance of display devices and the development of compression technology.

Image-related solutions loaded in various devices are rapidly developing in diverse ways. For example, there are solutions that provide image information in real time for video calls or video chatting.

In the case of video calls, however, a user and his or her surroundings are, regardless of his or her will, exposed to another person on the other side of the phone, thereby violating portrait rights and privacy of the user. As a result, the user may have an aversion to video calls.

Accordingly, this has led to a demand for a method of processing an image of a user and his or her surroundings and providing the processed image in real time to reduce the aversion to video calls while arousing the interest of the user.

### SUMMARY OF THE INVENTION

Aspects of the present invention provide a video call device which converts an image and displays the converted image in real time to arouse the interest of a user and remove the aversion of the user to video calls.

Aspects of the present invention also provide a video call method which is employed to convert an image and display the converted image in real time so as to arouse the interest of a user and remove the aversion of the user to video calls.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a video call device which performs a video call by exchanging images with another video call device in real time. The video call device includes: an image obtaining unit obtaining an original image in real time; an image processing unit comprising a first image conversion unit which receives the original image and converts the original image into a first conversion image in real time; and an interface unit transmitting the first conversion image.

According to another aspect of the present invention, there is provided a video call method used by video call devices to perform a video call by exchanging images with each other in real time. The video call method includes: obtaining an original image in real time; receiving the original image and converting the original image into a first conversion image in real time; and transmitting the first conversion image.

### BRIEF DESCRIPTION OF THE DRAWINGS

The above and other aspects and features of the present invention will become more apparent by describing in detail exemplary embodiments thereof with reference to the attached drawings, in which:

FIG. 1 is a block diagram of a video call device according to an exemplary embodiment of the present invention;

FIG. 2 is a block diagram of a first image conversion unit shown in FIG. 1;

FIGS. 3A through 3D respectively illustrate image conversion processes performed when an edge extraction unit shown in FIG. 2 extracts edges from an original image;

FIGS. 4A through 4D respectively illustrate image conversion processes performed when a color processing unit shown in FIG. 2 modifies color information of an original image to generate a cartoon image;

FIG. 5 shows cartoon images generated by combining images of FIG. 3D output from the edge extraction unit with images of FIG. 4D output from the color processing unit;

FIG. 6 illustrates conversion of an original image into a first conversion image (a cartoon image) according to exemplary embodiments of the present invention;

FIG. 7 illustrates conversion of the first conversion image shown in FIG. 6 into second conversion images according to exemplary embodiments of the present invention;

FIGS. 8A through 8C are schematic views illustrating the process of operating video call devices according to an exemplary embodiment of the present invention; and

FIG. 9 is a flowchart illustrating a video call method according to an exemplary embodiment of the present invention.

### DETAILED DESCRIPTION OF THE INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

Hereinafter, a video call device according to an exemplary embodiment of the present invention will be described with reference to the attached drawings.

A video call device according to an exemplary embodiment of the present invention can convert, in real time, an original image which is input in real time and provide a conversion image. Furthermore, the video call device can convert a portion of the conversion image back into a corresponding portion of the original image and provide the conversion image accordingly. As used herein, a “conversion image” denotes an image obtained by processing an original image, which is clearly recognizable to a user, to have visual effects by distorting or modifying the original image.

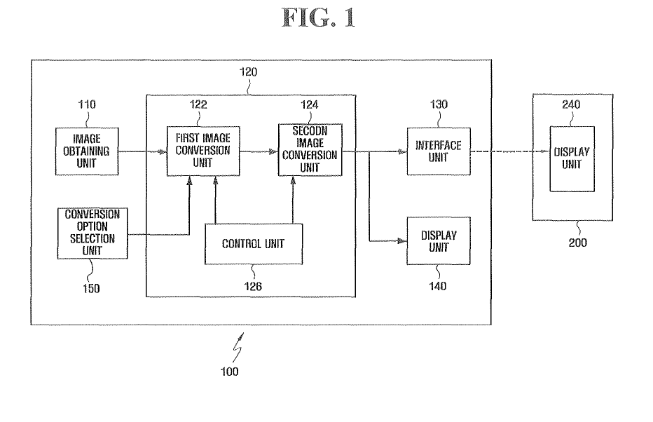

FIG. 1 is a block diagram of a video call device 100 according to an exemplary embodiment of the present invention.

Referring to FIG. 1, the video call device 100 according to the current exemplary embodiment includes an image obtaining unit 110 to which an original image is input in real time, an image processing unit 120 which processes and converts the original image and generates a conversion image, a display unit 140 which displays the conversion image, and an interface unit 130 which transmits the conversion image to an external destination. The conversion image transmitted by the interface unit 130 may be displayed on a display unit 240 of another client device 200 which is connected to the video call device 100 through wired or wireless communication.

Although not shown in the drawing, the video call device 100 may also include other known components needed for voice calls.

The image obtaining unit 110 obtains original images in real time. The original images may include both moving images and still images. The present invention relates to the video call device 100 which performs a video call by exchanging images with another device in real time. Thus, the following description will be based on the assumption that original images are moving images. As used herein, an “original image” denotes an image input to an apparatus, such as a camera, which has not been processed or modified to have visual effects. In mobile phones for performing video calls, the image obtaining unit 110 may be a built-in camera.

The image processing unit 120 may include a first image conversion unit 122 which generates a first conversion image, a second image conversion unit 124 which generates a second conversion image, and a control unit 126 which controls the first image conversion unit 122 and the second image conversion unit 124.

The first image conversion unit 122 processes an original image to have visual effects by distorting or modifying the original image and generates a first conversion image. Here, the first image conversion unit 122 may convert the original image into the first conversion image in real time. Examples of the first conversion image include a cartoon image, an edge image, and a reverse image.

A cartoon image is an image, such as a cartoon or a sketch, obtained by extracting and processing specified feature parts from an original image. An edge image is an image obtained by emphasizing edge portions of an original image. A reverse image is an image obtained by reversing an original image. Here, a reverse image may be colors image or grayscale image. Also, a reverse image may be obtained by reversing the right and left sides of an original image as in mirror reversal.

The process of generating a cartoon image as an example of the first conversion image will now be described.

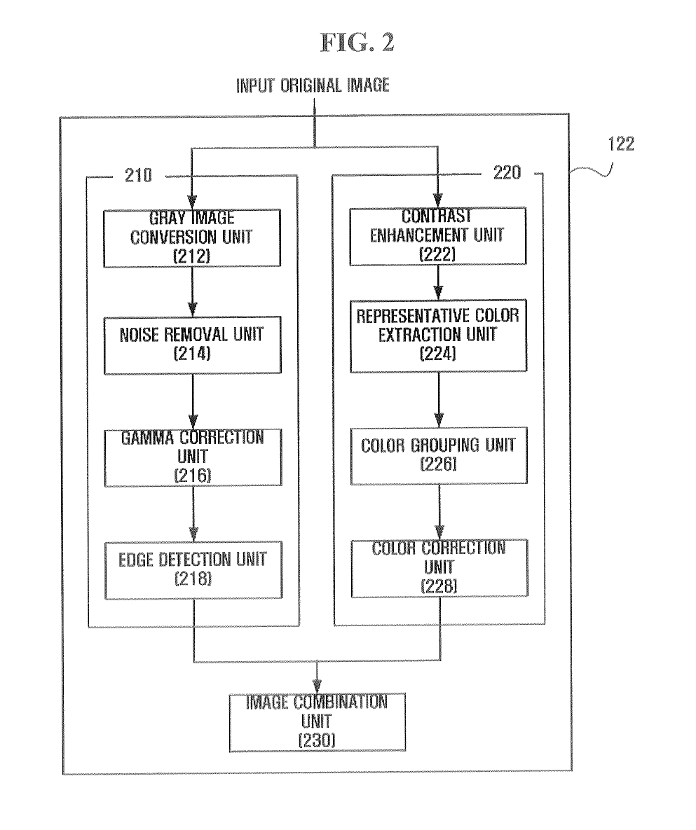

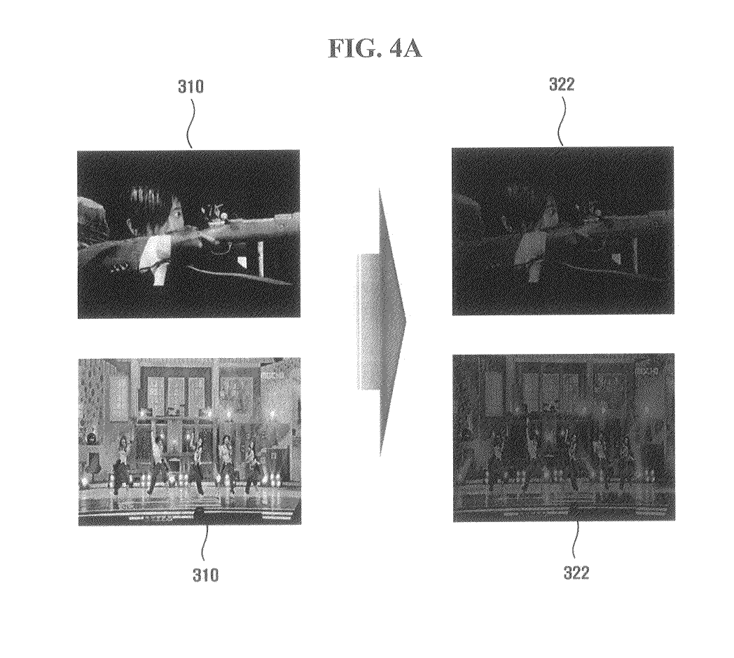

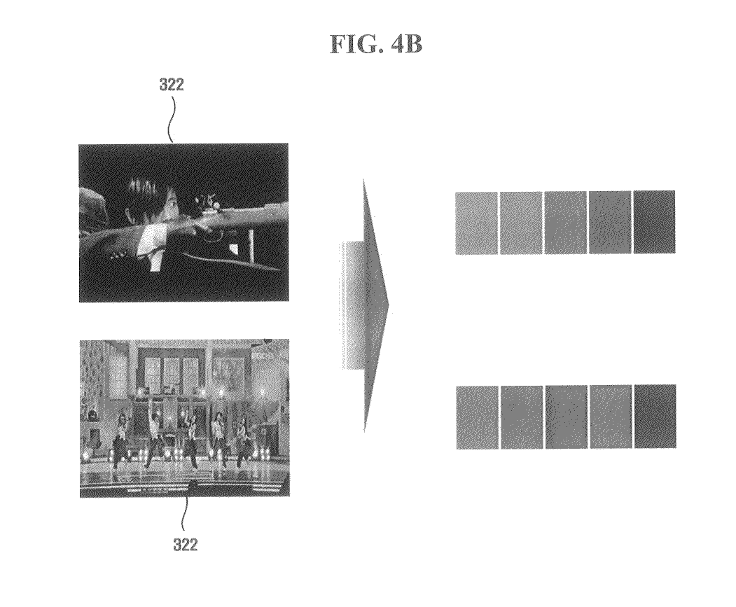

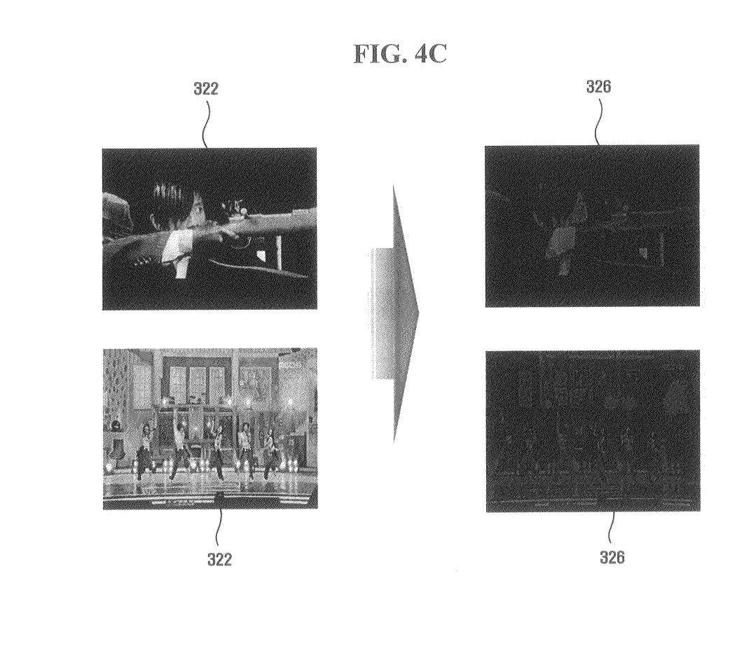

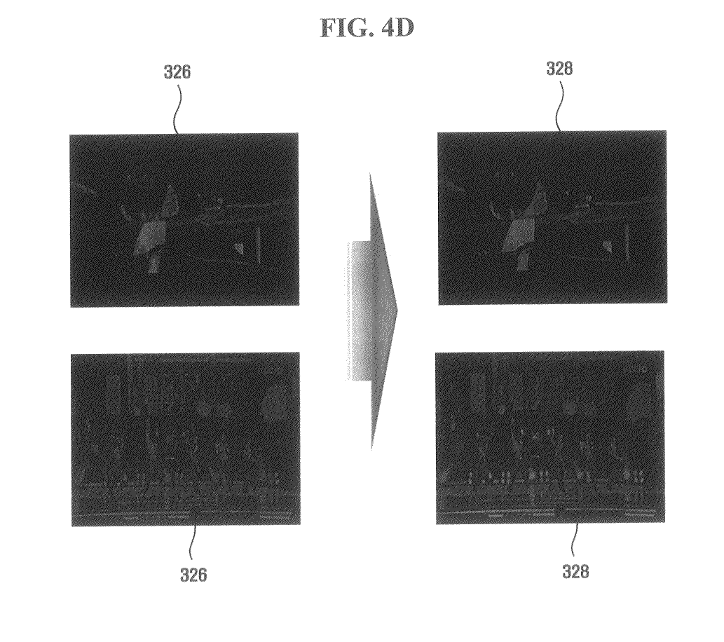

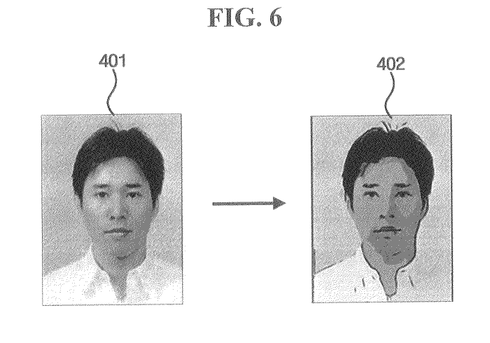

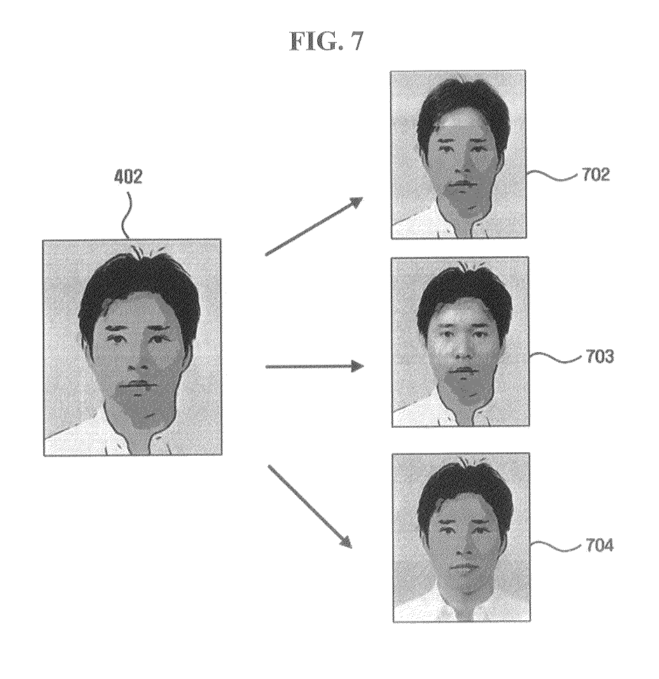

FIG. 2 is a block diagram of the first image conversion unit 122 shown in FIG. 1. FIGS, 3A through 3D respectively illustrate image conversion processes performed when an edge extraction unit 210 shown in FIG. 2 extracts edges Iron) an original image. FIGS. 4A through 4D respectively illustrate image conversion processes performed when a color processing unit 220 shown in FIG. 2 modifies color information of an original image and generates an image having the modified color information so as to generate a cartoon image. FIG. 6 illustrates conversion of an original image into a first conversion image (a cartoon image) according to exemplary embodiments of the present invention. FIG. 7 illustrates conversion of the first conversion image shown in FIG. 6 into second conversion images according to exemplary embodiments of the present invention.

Referring to FIG. 2, the first image conversion unit 122 generates a cartoon image from an original image. The first image conversion unit 122 may include the edge extraction unit 210, the color processing unit 220, and an image combination unit 230.

The edge extraction unit 210 may include a gray image conversion unit 212, a noise removal unit 214, a gamma correction unit 216, and an edge detection unit 218. The color processing unit 220 may include a contrast enhancement unit 222, a representative color extraction unit 224, a color grouping unit 226, and a color correction unit 228.

The edge extraction unit 210 extracts edges from an input original image by sequentially passing the original image through the gray image conversion unit 212, the noise removal unit 214, the gamma correction unit 216 and the edge detection unit 218 and generates an image having the extracted edges.

The color processing unit 220 performs cartoonization by arbitrarily distorting or partially omitting color information of an original image. For example, the color processing unit 220 modifies color information of an input original image by sequentially passing the original image through the contrast enhancement unit 222, the representative color extraction unit 224, the color grouping unit 226 and the color correction unit 228 and generates an image having the modified color information.

The image combination unit 230 combines the image generated by the edge extraction unit 210 with the image generated by the color processing unit 220 and finally generates a cartoon image.

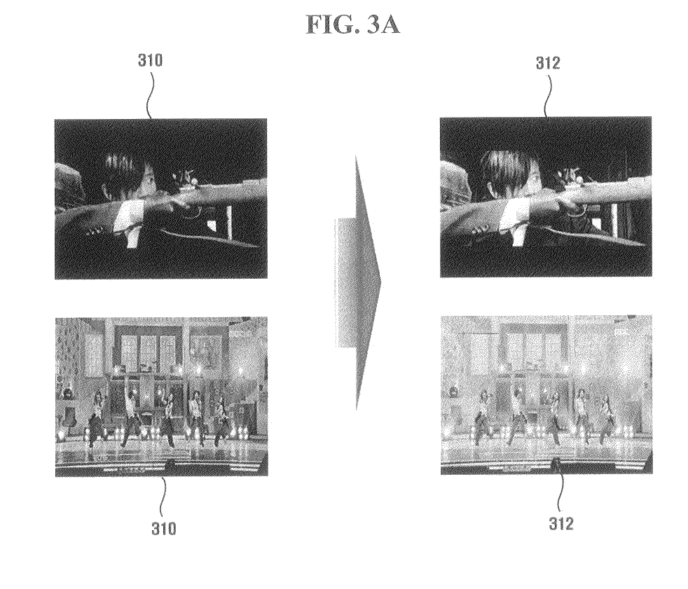

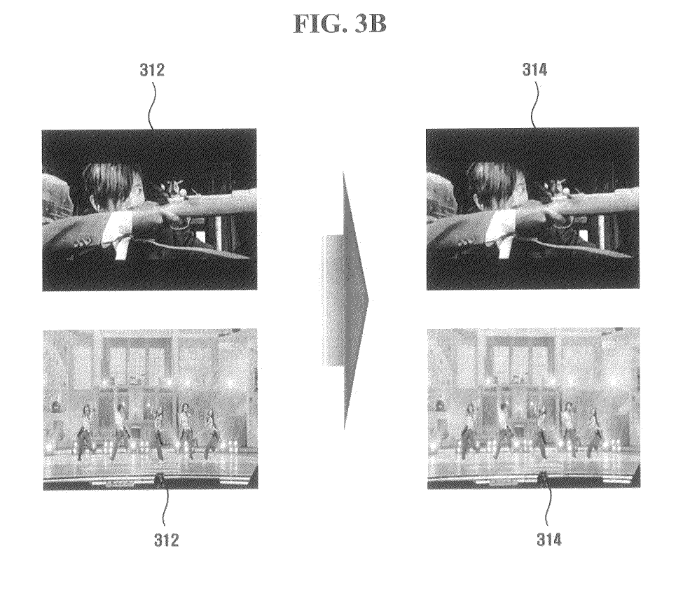

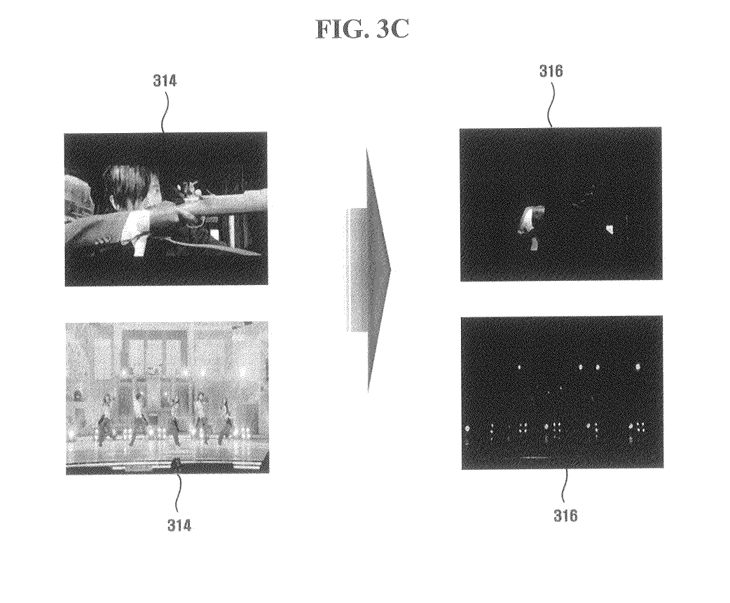

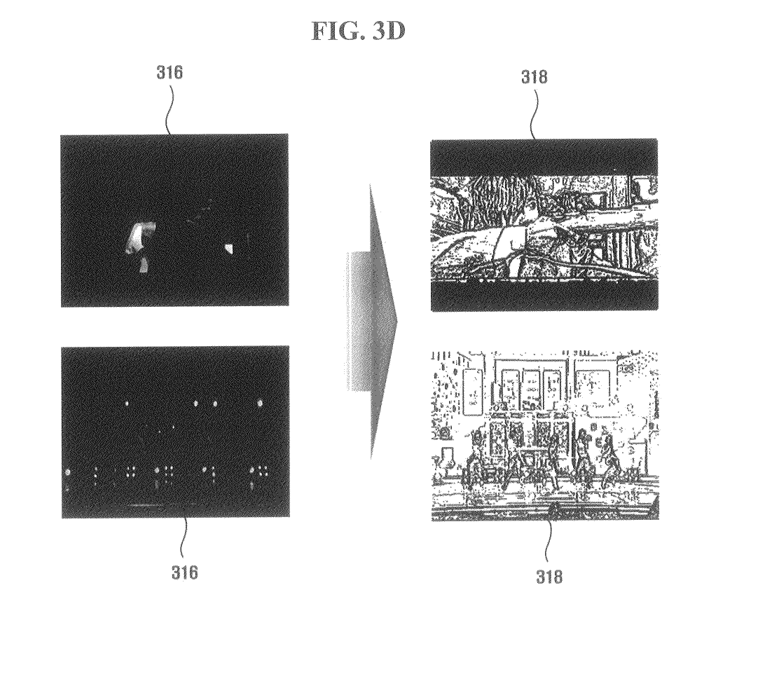

As described above, FIGS. 3A through 3D respectively illustrate image conversion processes performed when the edge extraction unit 210 extracts edges from an original image. Specifically, FIG. 3A illustrates a process in which the gray image conversion unit 212 converts original images 310 into gray images 312. FIG. 3B illustrates a process in which the noise removal unit 210 converts the gray images 312 shown in FIG. 3A into noiseless images 314. FIG. 3C illustrates a process in which the gamma correction unit 216 converts the noiseless images 314 shown in FIG. 3B into gamma-corrected images 316. Generally, gamma correction is used to capture, print, and display an image. Gamma correction makes a bright color brighter and a dark color darker. Thus, the execution of gamma correction during edge extraction according to the present invention leads to adjustment of color contrast, thereby enabling more accurate edge detection. FIG. 3D illustrates a process in which the edge detection unit 218 finally converts the gamma-corrected images 316 shown in FIG. 3C into edge-detected images 318.

Edges can also be extracted from an original image using known methods other than the above-described method.

As described above, FIGS. 4A through 4D respectively illustrate image conversion processes performed when the color processing unit 220 modifies color information of an original image and generates an image having the modified color information so as to generate a cartoon image. Specifically, FIG. 4A illustrates a process in which the contrast enhancement unit 222 converts original images 310 into contrast-enhanced images 322. FIG. 4B illustrates a process in which the representative color extraction unit 224 extracts representative colors from each of the contrast-enhanced images 322 shown in FIG. 4A. In FIG. 4B, five representative colors are extracted from each of the contrast-enhanced images 322. FIG. 4C illustrates a process in which the color grouping unit 226 converts the contrast-enhanced images 322 shown in FIG. 4B into images 326 of the extracted representative colors. FIG. 4D illustrates a process in which the color correction unit 228 finally converts the images 326 of the extracted representative colors shown in FIG. 4C into color-corrected images 328. After color grouping, the color correction unit 228 performs color correction on an unnatural color group.

To modify color information of an original image so as to generate a cartoon image from the original image, known methods other than the above-described method can also be used.

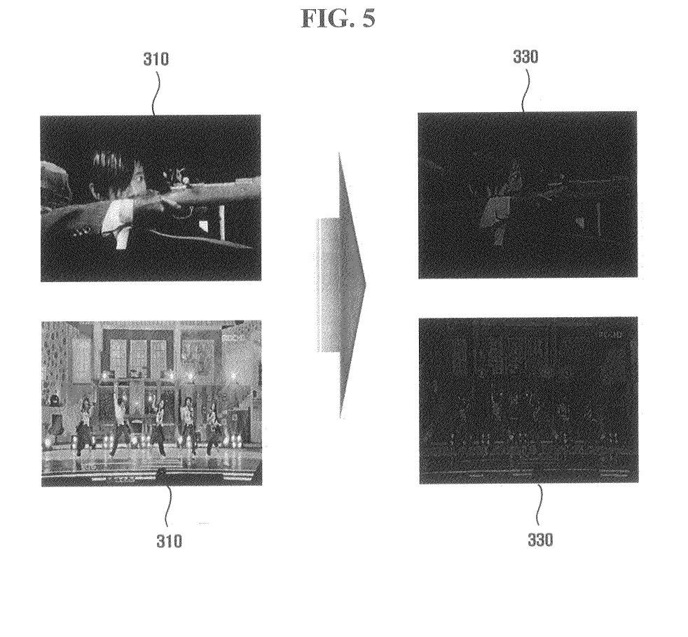

The image combination unit 230 finally combines the edge-detected images 318 of FIG. 3D output from the edge extraction unit 210 with the color-corrected mages 328 of FIG. 4D output from the color processing unit 220 to generate cartoon images 330 as shown in FIG. 5.

At a user's choice, the edge-detected images 318 output from the edge extraction unit 210, the color-corrected images 328 output from the color correction unit 220, or the cartoon images 330 output from the image combination unit 230 may be adopted as final images.

Referring back to FIG. 1, a conversion option selection unit 150 allows a user to adjust the method and degree of conversion of an original image by the image processing unit 120. For example, the conversion option selection unit 150 may allow a user to select any one of a cartoon image, an edge image and a reverse image, so that the first conversion image can be generated in the form of the selected image. Furthermore, the conversion option selection unit 150 may allow the user to adjust the degree of conversion by providing detailed options for each of the cartoon image, the edge image, and the reverse image. For example, the conversion option selection unit 150 may allow the user to adjust the degree of distortion of colors, contrast, and the thickness of edge lines, so that the first conversion image can be generated accordingly.

The second image conversion unit 124 generates the second conversion image using the first conversion image and the original image. The second image conversion unit 124 replaces one or more portions of the first conversion image with one or more corresponding portions of the original image. That is, the second image conversion unit 124 replaces a portion of the first conversion image in which a subject is not clearly recognizable with a corresponding portion of the original image, so that the corresponding portion of the original image in which the subject is clearly recognizable can be displayed.

The control unit 126 controls the position or scope of a portion of the original image which is to be included in the second conversion image. The control unit 126 controls the first image conversion unit 122 and the second image conversion unit 124 so as to control generation of the first conversion image and the second conversion image. For example, when receiving a signal indicating the position of a portion of the first conversion image which is to be replaced by a corresponding portion of the original image, the control unit 126 provides position information of the portion of the first conversion image to the second image conversion unit 124 and thus controls the second image conversion unit 124 to generate the second conversion image accordingly.

An original image 401 is shown on the left side of FIG. 6, and a cartoon image 402 into which the original image 401 has been converted by the first image conversion unit 122 is shown on the right side of FIG. 6.

The original image 401 is an image captured by, e.g., a camera. It is such a clear photographed image that even details of a subject are recognizable to a user. This original image 401 can be converted into the cartoon image 402 which is the first conversion image.

The cartoon image 402 is an image obtained by exaggerating feature parts of the original image 401 or simplifying colors of the original image 401 to create cartoon-like effects. The original image 401 may be converted into the cartoon image 402 to such an extent that the subject in the cartoon image 402 is not clearly recognizable to a user.

FIG. 7 illustrates conversion of the cartoon image 402 shown in FIG. 6 into second conversion images 702 through 704.

A region of each of the second conversion images 702 through 704 includes an image identical to that of a corresponding region of the original image 401, and the other regions of each of the second conversion images 702 through 704 respectively include images identical to those of corresponding regions of the first conversion image 402. Here, any region of each of the second conversion images 702 through 704 can be selected as the region including the image identical to that of the corresponding region of the original image 401. The position and size of the region including the image identical to that of the corresponding region of the original image 401 may vary as desired. In FIG. 7, the cartoon image 402 is divided into three regions, and each of the three regions of the cartoon image 402 is replaced by a corresponding region of the original image 401. Accordingly, each of the second conversion images 702 through 704 is the cartoon image 402 having one of the three regions replaced by a corresponding region of the original image 401.

The first conversion image and the second conversion image obtained as described above are transmitted to an external device via the interface unit 130 or are displayed on the display unit 140.

The interface unit 130 connects the video call device 100 to an external device through wired/wireless communication. In particular, the interface unit 130 may transmit a conversion image output from the first image conversion 122 or the second image conversion unit 124 to another client device 200 which is connected to the video call device 100 for a video call or may receive a conversion image from the client device 200.

The display unit 140 displays a conversion image output from the image processing unit 120. The display unit 140 may also display a conversion image received from the client device 200 which is connected to the video call device 100 for a video call. Furthermore, the display unit 140 may display a conversion image output from the image processing unit 120 and transmitted to the client device 200 which is connected to the video call device 100 for a video call.

One example of the display unit 140 is a liquid crystal display. A liquid crystal display may include a touch panel to which a touch signal can be input through the screen thereof. That is, while monitoring the first conversion image or the second conversion image displayed on the display unit 140, a user can set a section or region of the displayed image by selecting a portion of the displayed image. Once the user selects a section by inputting a touch signal to the display unit 140, information about the selected section is delivered to the control unit 126 and is there used as a control signal for generating the first conversion image and the second conversion image.

Meanwhile, a region of a screen image displayed on the display unit 140 can be selected using not only a touch panel but also an input unit such as a keypad, a keyboard, a joystick, or a mouse.

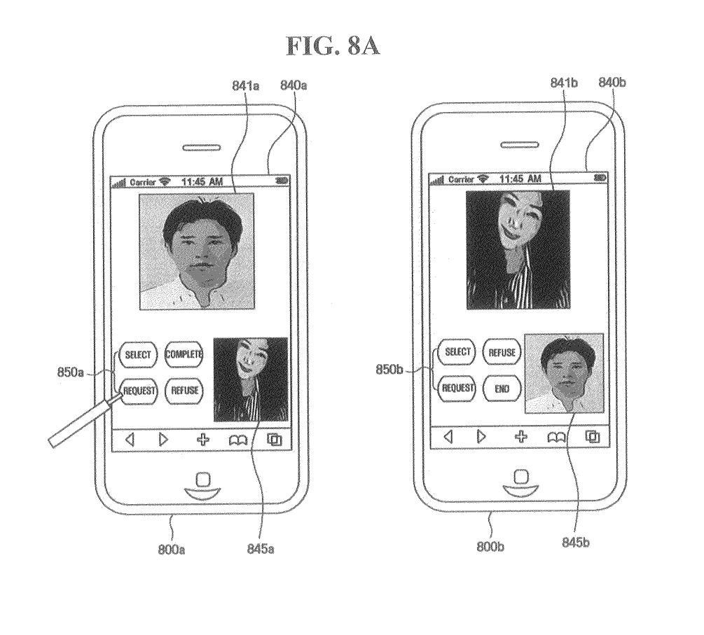

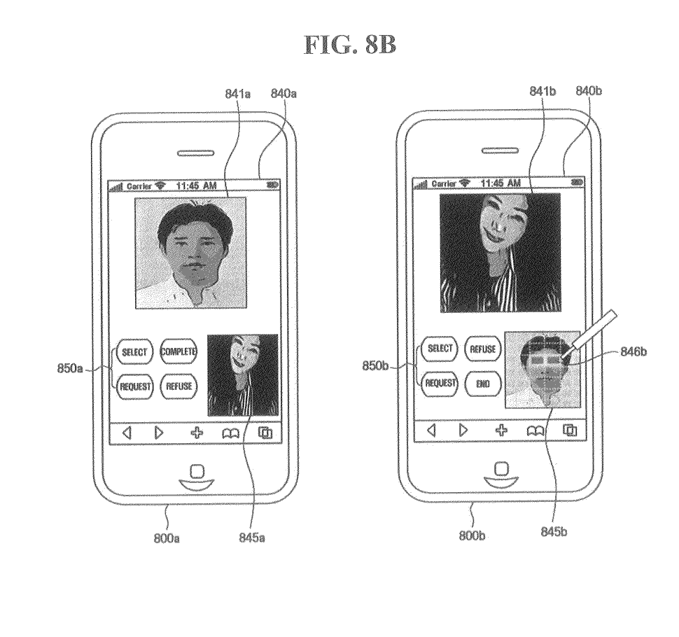

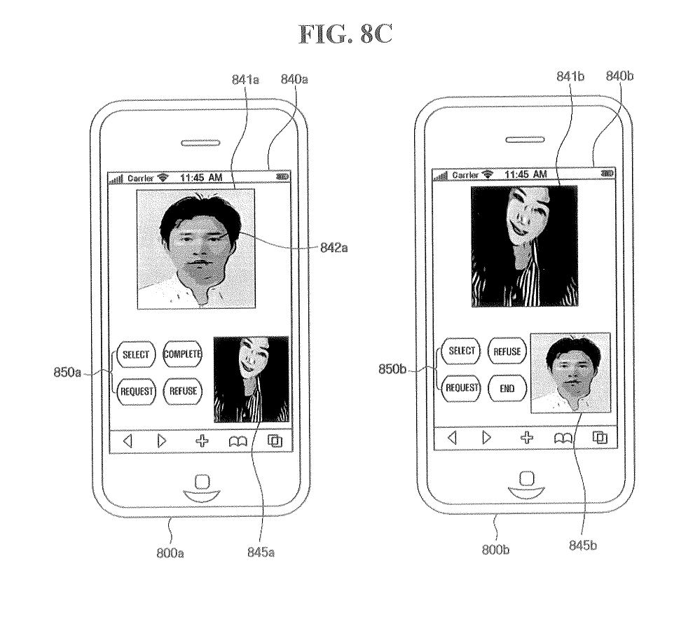

FIGS. 8A through 8C are schematic views illustrating the process of operating video call devices according to an exemplary embodiment of the present invention. Specifically, FIGS. 8A through 8C show a process in which a first device 800a and a second device 800b perform a video call while exchanging a first conversion image or a second conversion image with each other in real time.

Referring to FIG. 8A, the first device 800a and the second device 800b may respectively include first display regions 841a and 841b, second display regions 845a and 845b, and keypad regions 850a and 850b on display units 840a and 840b thereof.

The first display region 841a of the first device 800a is where a conversion image transmitted to the second device 800b, which performs a video call with the first device 800a, is displayed, and the first display region 841b of the second device 800b is where a conversion image transmitted to the first device 800a is displayed. In addition, the second display region 845a of the first device 800a is where a conversion image received from the second device 800b is displayed, and the second display region 845b of the second device 800b is where a conversion image received from the first device 800a is displayed.

The keypad regions 850a and 850b are input units used to input control input signals for controlling the first device 800a and the second device 800b. That is, when each of the first device 800a and the second device 800b uses a touch panel, a predetermined region of each of the display units 840a and 840b may be used as one of the keypad regions 850a and 850b. Thus, when a user inputs a touch signal to one of the keypad regions 850a and 850b, a corresponding control input signal may be input.

As shown in FIG. 8A, vides call devices according to an exemplary embodiment can, in real time, convert their respective original images into first conversion images and provide the first conversion images to each other during a video call.

FIG. 8B shows a process in which a user of the second device 800b selects a region 846b, which is to be replaced by a corresponding region of an original image, from the second display region 845b.

After selecting the region 846b from the second display region 845b, if the user of the second device 800b touches the “Select” key in the keypad region 850b, information about the selected region 846b is input to the second device 800b and is sent to a user of the first device 800a. Here, the information about the selected region 846b may be provided to the control unit 126 of the first device 800a.

FIG. 8C shows a region 842a of the first display region 841a of the first device 800a and a region of the second display region 845b of the second device 800b which are replaced by corresponding regions of an original image and are displayed accordingly.

The position or size of the region 842a, which is replaced by a corresponding region of the original image, may be changed by the user of the second device 800b. Meanwhile, the user of the first device 800a can also select a region, which is to be replaced by a corresponding region of an original image, from the second display region 845a of the first device 800a and request the second device 800b to provide the corresponding region of the original image.

Hereinafter, a video call method according to an exemplary embodiment of the present invention will be described.

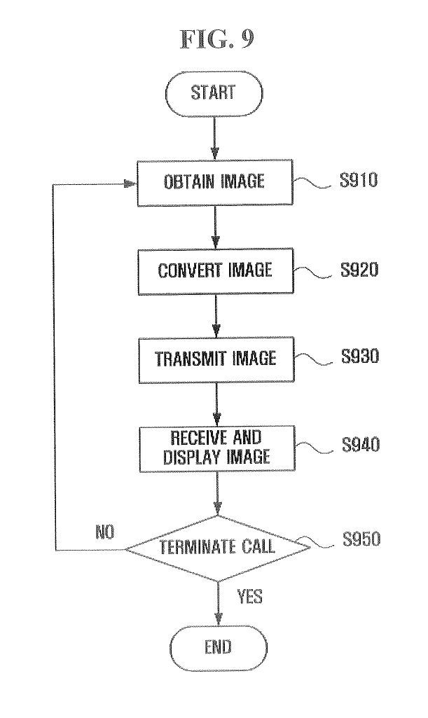

FIG. 9 is a flowchart illustrating a video call method according to an exemplary embodiment of the present invention.

Operations of the video call method will be described based on the assumption that a first device and a second device are connected to each other through wired/wireless connection for a video call.

First, the image obtaining unit 110 obtains an original image in real time (operation S910). If the first and second devices are mobile phones, the image obtaining unit 110 may be a camera built in each of the mobile phones.

The image processing unit 120 converts the original image obtained by the image obtaining unit 110 in real time into a first conversion image in real time. Based on agreement between users of the first and second devices, the image processing unit 120 may generate a second conversion image by replacing a region of the first conversion image with a corresponding region of the original image (operation S920).

Each of the first and second devices transmits the first conversion image or the second conversion image to the other device (operation S930).

Each of the first and second devices displays a conversion image, into which its original image has been converted, in a first display region of the display unit 140. In addition, each of the first and second devices receives a conversion image from the other device and displays the received conversion image in a second display region of the display unit 140 (operation S940).

In the present invention, operations S910 through S940 in which the first and second devices exchange conversion images with each other and display the conversion images are performed in real time until the video call is terminated (operation S950).

A video call device and method according to exemplary embodiments of the present invention provide the following advantages.

First, since an image obtained by a camera is converted into an image (e.g., a cartoon image) which is not clearly recognizable, violation of portrait rights and privacy of a user can be prevented.

Second, a user is prevented from, regardless of his or her will, being exposed to another person on the other side of the phone, thereby removing the aversion of the user to video calls.

Third, since a user can adjust the degree of conversion of an image as desired, his or her interest can be aroused.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A video call device which performs a video call by exchanging images with another video call device in real time, the video call device comprising:
an image obtaining unit obtaining an original image in real time;
an image processing unit comprising a first image conversion unit which receives the original image and converts the original image into a first conversion image in real time; and
an interface unit transmitting the first conversion image.

2. The video call device of claim 1, wherein the image processing unit comprises:
an edge extraction unit extracting edges of the original image; and
a color processing unit modifying color information of the original image.

3. The video call device of claim 2, wherein the image processing unit further comprises an image combination unit combining an image output from the edge extraction unit with an image output from the color processing unit.

4. The video call device of claim 1, wherein the first conversion image is any one of a cartoon image, an edge image, and a reverse image.

5. The video call device of claim 1, wherein the image processing unit further comprises a second image conversion unit replacing one or more portions of the first conversion image with one or more corresponding portions of the original image and generating a second conversion image, and the interface unit transmits the second conversion image.

6. A video call method used by video call devices to perform a video call by exchanging images with each other in real time, the video call method comprising:
obtaining an original image in real time;
receiving the original image and converting the original image into a first conversion image in real time; and
transmitting the first conversion image.

7. The video call method of claim 6, wherein the first conversion image is any one of a cartoon image, an edge image, and a reverse image.

8. The video call method of claim 6, further comprising displaying a first conversion image received from another video call device.

9. The video call method of claim 6, wherein the converting of the original image into the first conversion image comprises replacing one or more portions of the first conversion image with one or more corresponding portions of the original image and generating a second conversion image.
